(19) United States
(12) Patent Application Publication
(10) Pub. No.: US 2016/0117261 A1
(43) Pub. Date: Apr. 28, 2016

(54) RESPONSE VALIDATION MECHANISM FOR TRIGGERING NON-INVASIVE RE-TEST ACCESS OF INTEGRATED CIRCUITS

(71) Applicant: TEXAS INSTRUMENTS INCORPORATED, Dallas, TX (US)

(72) Inventors: Bhargavi Nisarga, Allen, TX (US); Eric Loeffler, Munich (DE)

(73) Assignee: TEXAS INSTRUMENTS INCORPORATED, Dallas, TX (US)

(21) Appl. No.: 14/279,538

(22) Filed: May 16, 2014

(51) Int. Cl. G06F 12/14; G06F 11/22; H04L 9/30; H04L 9/08

(52) U.S. Cl. CPC G06F 12/1408; H04L 9/0822; G06F 11/2247; H04L 9/30; G06F 2212/1052

(57) ABSTRACT

In an embodiment of the invention, response validation offers increased integrated circuit security by using a unique password or re-test key for every integrated circuit manufactured. Non-invasive re-test of an IC can be performed using an encryption input.

### BACKGROUND

Integrated circuits (IC) are not always produced by companies that design or sell them. Anyone with access to a manufacturing process for integrated circuits could, in theory, introduce some change to the final IC. For complex ICs, small changes can have large effects and these changes can be difficult to detect. The threat of design alteration can be especially relevant to government agencies. Resolving doubt about IC integrity is one way to reduce technology vulnerabilities in military, finance, energy and political sectors of an economy. Since fabrication of integrated circuits in untrustworthy factories may occur, encryption and detection techniques are needed to verify the origin of manufacturing of the IC.

### BRIEF DESCRIPTION OF THE DRAWINGS

FIG. 1 is a block diagram illustrating a high level description of a response generation according to an embodiment of the invention.

FIG. 2 is a block diagram illustrating a high level description of a response validation according to an embodiment of the invention.

### DETAILED DESCRIPTION

In an embodiment of the invention, response validation offers increased device (IC) security by using a unique password or re-test key for every integrated circuit manufactured. Non-invasive re-test of an IC can be performed using an encryption input.

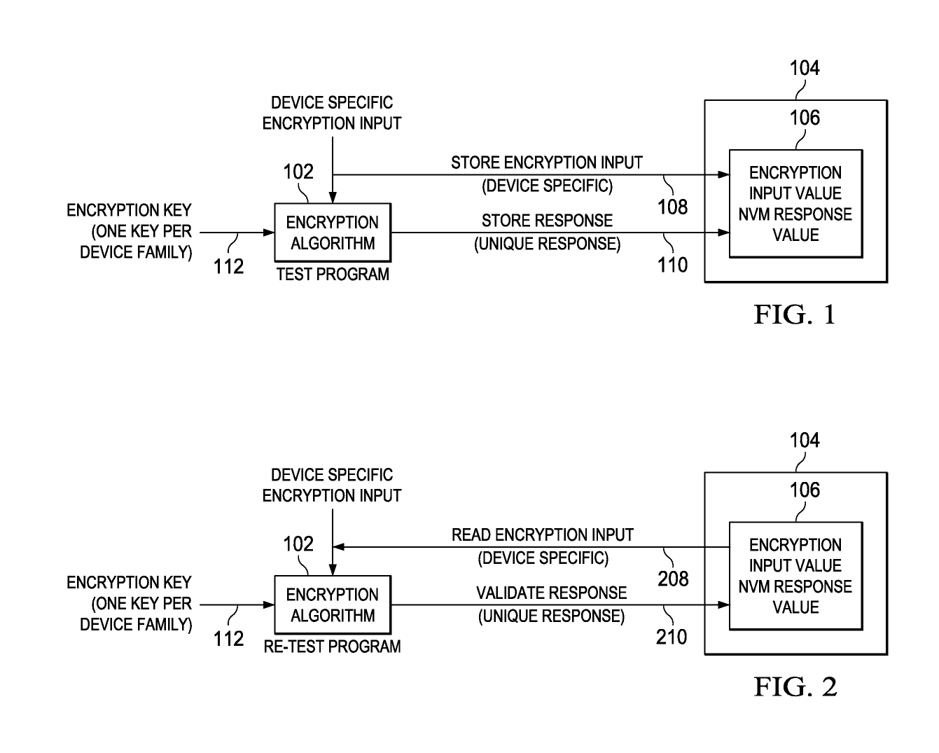

FIG. 1 is a block diagram illustrating a high level description of a response generation according to an embodiment of the invention. An encryption key 112 and a device specific encryption input 108 are input to an encryption algorithm 102. The device specific encryption input 108 is a unique value available or generated within the device 104 or externally. The encryption key 112 is a secret key that is generated for a specific family of integrated circuits. The stored response 110 generated by the encryption algorithm 102 is stored in secure non-volatile memory (NVM) 106 along with the device specific encryption input 108.

FIG. 2 is a block diagram illustrating a high level description of a response validation according to an embodiment of the invention. The encryption key 112 and a device read encryption input 208 (read from the NVM 106) are input to an encryption algorithm 102. When the device read encryption input 208 and the encryption key are valid, the encryption algorithm 102 inputs a validate response 210 into the device 104. After the validate response has been received by the device 104, the device 104 may be retested.

What is claimed is:

1. A method for triggering non-invasive re-test access of an integrated circuit comprising:
providing an encryption key to a first input of an encryption algorithm;
providing a device specific encryption value to a second input of the encryption algorithm;
wherein the encryption algorithm provides a stored response, the stored response determined by the encryption key and the device specific encryption value;
electronically storing the stored response in a non-volatile memory (NVM) on the integrated circuit;
electronically storing the device specific encryption value in the NVM on the integrated circuit;
providing the encryption key to the first input of the encryption algorithm;
reading the device read encryption input from the NVM into the second input of the encryption algorithm;
providing a validate response to the integrated circuit when the encryption algorithm verifies that the read encryption key and the device read encryption input are valid; and
retesting the integrated circuit.

2. The method of claim 1 wherein the device specific encryption value is generated external to the integrated circuit.

3. The method of claim 1 wherein the device specific encryption value is generated on the integrated circuit.
